(19) United States
(12) Patent Application Publication
(10) Pub. No.: US 2006/0052248 A1
(43) Pub. Date: Mar. 9, 2006

(54) Use of a substance with oxytocin activity in order to stimulate plant growth

(76) Inventors: Kerstin Uvnas-Moberg, Sveavagen 9D (SE); Bengt Lundegardh, Tistronvagen 5 (SE)

Correspondence Address: YOUNG & THOMPSON, 745 SOUTH 23RD STREET, 2ND FLOOR, ARLINGTON, VA, 22202, US

(21) Appl. No.: 10/481,627

(22) PCT Filed: Jun. 19, 2002
(86) PCT No.: PCT/SE02/10208

§ 371 Date: Jan. 14, 2005

(30) Foreign Application Priority Data
Jun. 19, 2001 (SE) 0102185-6

(51) Int. Cl. A01N 43/00

(52) U.S. Cl. 504/209

(57) ABSTRACT

The present invention relates to the use of at least one substance with oxytocin activity in order to stimulate plant growth. It also relates to the use of a composition comprising a substance with oxytocin activity in order to stimulate plant growth.

The present invention rates to the use of at least one compound in order to stimulate plant growth. It also relates to the use of a composition in order to stimulate plant growth. It also relates to a composition comprising such a compound.

### BACKGROUND OF THE INVENTION

In most cases, the preliminary stage to a plant is a seed. The seed is a resting structure. The process of germination is the absorption of water by the seed, the reactivation of metabolism and the initiation of growth. The seed contains an embryo; one end of this embryo, the radicle will form the root of the plant; the other end, the plumule, will form the stem and leaves. The embryo also has cotyledons or seed leaves (one in monocots, two in dicots, and many in gymnosperms) which may be small and occupy only a small part of the seed, as in monocots, or may be large enough almost completely to fill the seed, as in beans and many other dicots.

In the germination of a monocot seedling, the radicle grows downward through the split seed coat to produce the primary root, and the shoot, encased in its protective sheath, the coleoptile, grows upward. The species Agrostis tenuis, Triticum sativum and Lactuca sativa are all monocots. For dicots, however, the plumule is not protected by a coleoptile. Instead, the plumule pushes through the soil in a “crook” form, called the plumule hook. In this way, the delicate newly forming leaves of the plumule are not damaged.

Generally, it is highly desirable to stimulate plant growth but not to stimulate weed growth. Accordingly, there has been a long-felt need to find a cheap agent that effectively stimulates plant growth but does not stimulate weed growth. Plant hormones are known to stimulate plant growth. Examples of plant hormones are auxins, gibberelins, cytokinins and abscisic acid. A problem with these agents is that they are relatively expensive and they may be toxic in high concentrations. Alternatively, herbicides such as phenoxy acids may be used in order to inhibit weed growth. A problem with herbicides is above all tie high toxicity thereof. As a result, many herbicides have been prohibited by law.

The above-mentioned problems have been solved by using oxytocin as a stimulating agent for plant growth. Oxytocin is a cheap agent that is produced in the human body. Oxytocin has shown to be a more potent stimulating agent for plant growth than the plant hormones mentioned above. The mechanism of action of oxytocin is probably by improving the nutrient uptake, transport and release via roots in combination with a better photosynthesis or translocation i e redistribution of inorganic and organic compounds between tissues and inclusion in seeds or other storage organs. In seeds, oxytocin stimulates germination but above all most likely the turnover and translocation of organic material from the nucleus to root and shoot embryos. Oxytocin may be used in order to break dormancy, stimulate germination and the growth of the germ. By a faster early growth, the plant will compete better with weed. In later stages, oxytocin may influence initiation of flower primodium and increase the survival rate of florets and seeds by better inclusion of organic matter and an increased translocation of nutrient and compounds to the seeds. This may lead to more even or bigger harvests with the same quality. Oxytocin can also effect next generations causing more rapid germination and enhanced growth by influence of genomes or seed composition.

New plants could also be developed by vegetative propagation for example from bulbs, tubers, meristimatic tissues such as buds, apical meristems, cell cultures and cuttings. Cuttings can be used for grafting or planting. Unicellular algae are propagated by cell division.

The action of oxytocin can also be used by stimulation of cell division and in such a way enhanced growth of plants, including unicellular algae, propagated by processes mentioned above.

It should be noted that the term “plant” within the context of the present invention includes all groups of plants as is recognized by a person skilled in the art. Such groups of plants include e g gymnosperms, angiosperms, monocotyledons (monocots), dicotyledons (dicots) and algae.

There are different processes described for the synthetical production of oxytocin; commercial processes are for instance described in U.S. Pat. Nos. 2,938,891 and 3,076,797.

Oxytocin was one of the first peptide hormones to be isolated and sequenced. It is a nonapeptide with two cysteine residues that form a disulfide bridge between positions 1 and 6 and corresponds to the formula

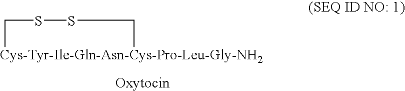

There are several oxytocin derivatives, i.e. compounds with a structure similar to that of oxytocin. The inventors have preliminary indications that other oxytocin derivatives than oxytocin may stimulate plant growth, as well as parts of the oxytocin molecule. Such oxytocin derivatives and parts of the oxytocin molecule with the same or similar effects on plant growth as oxytocin are generally called substances with oxytocin activity. Substances with oxytocin activity also include precursors, metabolic derivatives, oxytocin agonists and analogues displaying the same properties.

WO 00/18424 discloses the use of substances with oxytocin activity for the preparation of a pharmaceutical composition in order to improve cell regeneration. By cell regeneration is meant the recovery of a human or animal body by a controlled and helpful generation of existing and new cells as well as cell maturation in order to replace damaged cells. WO 00/18425 discloses the use of the same substances in order to promote growth of human and animal cells. However, none of these documents describe the generation and growth of plant cells. Accordingly, it is not previously known from these documents that oxytocin and oxytocin derivatives or parts of the oxytocin molecule may stimulate plant growth.

The stimulating effect of oxytocin on plant growth is shown in the Examples. In Example 1, it was shown that oxytocin increased the amount of germinated seeds and stimulated the growth of seeds for the species winter wheat (Triticum sativum) and bent (Agrostis tenuis). In Example 2, it was shown that oxytocin increased the growth of lettuce (Lactuca saliva).

### SUMMARY OF THE INVENTION

The present invention relates to the use of at least one substance with oxytocin activity in order to stimulate plant growth. It also relates to the use of a composition comprising at least one substance with oxytocin activity in order to stimulate plant growth. The invention also relates to a composition comprising at least one substance with oxytocin activity.

### DETAILED DESCRIPTION OF THE INVENTION

One object of the present invention is the use of at least one substance with oxytocin activity in order to stimulate plant growth.

It is preferred that the at least one substance is selected from the group consisting of the following compounds: 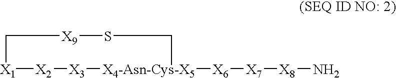
wherein

X₁ is selected from the group consisting of Cys, Mpa and nothing,

X₂ is selected from the group consisting of Tyr, (O-methyl-Tyr), Phe, and nothing,

X₃ is selected from the group consisting of Ile, Val, Hoph, Phe, Cha, and nothing,

X₄ is selected from the group consisting of Gla, Ser, Thr, Cit, Arg, and Daba,

X₅ is selected from the group consisting of Pro, and nothing,

X₆ is selected from the group consisting of Ile, Leu, nothing, Val, Hos, Daba, Thr, Arg, and Cit,

X₇ is selected from the group consisting of Gly, nothing, and Ala,

X₈ is selected from the group consisting of Gly, and nothing,

X₉ is selected from the group consisting of CH₂ and S;

as well as salts thereof.

The cystein disulfide bridge is only present when X₁ represents Cys or Mpa, X₂ represents Tyr, (O-methyl-Tyr) or Phe, and X₃ represents Ile, Val, Hoph, Phe or Cha.

By “nothing” is meant that the letters respectively may have no meaning or may represent a bond and that there may be a direct bond between the items (letter, atom or group) situated to the right and to the left, respectively, of the letter designating “nothing”. For example, in SEQ ID NO: 2 above, when only X₁ designates nothing, the resulting molecule corresponds to X₂-X₃-X₄-Asn-Cys-X₅-X₆-X₇-X₈-NH₂. When only X₈ designates nothing, the X₇ residue is amidated.

It is even more preferred that the at least one substance is selected from the group consisting of the following compounds:

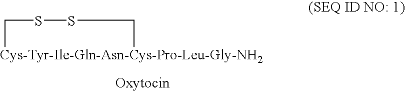

X₁ is Cys, X₂ is Tyr, X₃ is Ile, X₄ is Gln, X₅ is Pro, X₆ is Leu, X₇ is Gly, is nothing, and X₉ is S in Claim 2 and 6

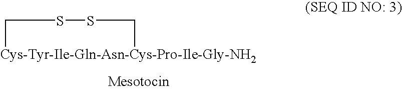

X₁ is Cys, X₂ is Tyr, X₃ is Ile, X₄ is Gln, X₅ is Pro, X₆ is Ile, X₇ is Gly, X₈ is nothing, and X₉ is S in Claim 2 and 6

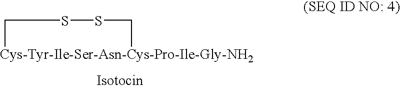

X₁ is Cys, X₂ is Tyr, X₃ is Ile, X₄ is Ser, X₅ is Pro, X₆ is Ile, X₇ is Gly, X₈ is nothing, and X₉ is S in Claim 2 and 6

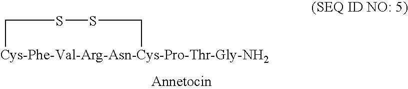

X₁ is Cys, X₂ is Phe, X₃ is Val, X₄ is Arg, X₅ is Pro, X₆ is Thr, X₇ is Gly, X₈ is nothing, and X₉ is S in Claim 2 and 6

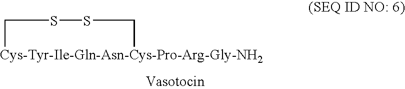

X₁ is Cys, X₂ is Tyr, X₃ is Ile, X₄ is Gln, X₅ is Pro, X₆ is Arg, X₇ is Gly, X₈ is nothing, and X₉ is S in Claim 2 and 6

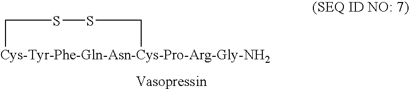

X₁ is Cys, X₂ is Tyr, X₃ is Phe, X₄ is Gln, X₅ is Pro, X₆ is Arg, X₇ is Gly, X₈ is nothing, and X₉ is S in Claim 2 and 6

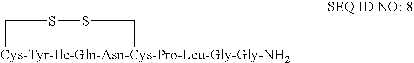

X₁ is Cys, X₂ is Tyr, X₃ is Ile, X₄ is Gln, X₅ is Pro, X₆ is Leu, X₇ is Gly, X₈ is Gly, and X₉ is S in Claim 2 and 6

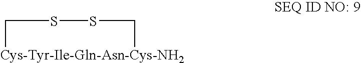

X₁ is Cys, X₂ is Tyr, X₃ is Ile, X₄ is Gln, X₅-X₈ is nothing, and X₉ is S in Claim 2 and 6

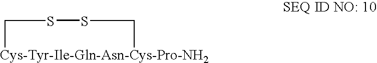

X₁ is Cys, X₂ is Tyr, X₃ is Ile, X₄ is Gln, X₅ is Pro, X₆-X₈ is nothing, and X₉ is S in Claim 2 and 6

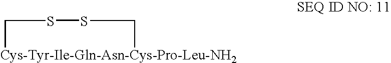

X₁ is Cys, X₂ is Tyr, X₃ is Ile, X₄ is Gln, X₅ is Pro, X₆ is Leu, X₇-X₈ is nothing, and X₉ is S in Claim 2 and 6

| | |
|---|---|
| Tyr-Ile-Gln-Asn-Cys-Pro-Leu-Gly-NH₂ | SEQ ID NO:12 |

X₁ is nothing, X₂ is Tyr, X₃ is Ile, X₄ is Gln, X₅ is Pro, X₆ is Leu, X₇ is Gly, X₈ is nothing, and X₉ is S in Claim 2 and 6

| | |
|---|---|
| Ile-Gln-Asn-Cys-Pro-Leu-Gly-NH₂ | SEQ ID NO:13 |

X₁-X₂ is nothing, X₃ is Ile, X₄ is Gln, X₅ is Pro, X₆ is Leu, X₇ is Gly, X₈ is nothing, and X₉ is S in Claim 2 and 6

| | |
|---|---|
| Gln-Asn-Cys-Pro-Leu-Gly-NH₂ | SEQ ID NO:14 |

X₁-X₃ is nothing, X₄ is Gln, X₅ is Pro, X₆ is Leu, X₇ is Gly, X₈ is nothing, and X₉ is S in Claim 2 and 6

| | |
|---|---|
| Ile-Gln-Asn-Cys-Pro-NH₂ | SEQ ID NO:15 |

X₁-X₂ is nothing, X₃ is Ile, X₄ is Gln, X₅ is Pro, X₆-X₈ is nothing, and X₉ is S in Claim 2 and 6

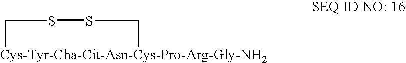

X₁ is Cys, X₂ is Tyr, X₃ is Cha, X₄ is Cit, X₅ is Pro, X₆ is Arg, X₇ is Gly, X₈ is nothing, and X₉ is S in Claim 2 and 6

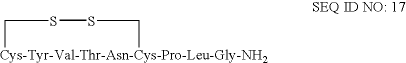

X₁ is Cys, X₂ is Tyr, X₃ is Val, X₄ is Thr, X₅ is Pro, X₆ is Leu, X₇ is Gly, X₈ is nothing, and X₉ is S in Claim 2 and 6

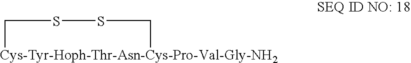

X₁ is Cys, X₂ is Tyr, X₃ is Hoph, X₄ is Thr, X₅ is Pro, X₆ is Val, X₇ Gly, X₈ is nothing, and X₉ is S in Claim 2 and 6

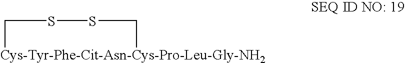

X₁ is Cys, X₂ is Tyr, X₃ is Phe, X₄ is Cit, X₅ is Pro, X₆ is Leu, X₇ is Gly, X₈ is nothing, and X₉ is S in Claim 2 and 6

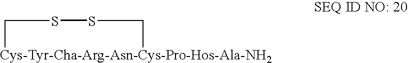

X₁ is Cys, X₂ is Tyr, X₃ is Cha, X₄ is Arg, X₅ is Pro, X₆ is Hos, X₇ is Ala, X₈ is nothing, and X₉ is S in Claim 2 and 6

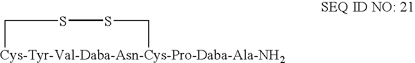

X₁ is Cys, X₂ is Tyr, X₃ is Val, X₄ is Daba, X₅ is Pro, X₆ is Daba, X₇ is Ala, X₈ is nothing, and X₉ is S in Claim 2 and 6

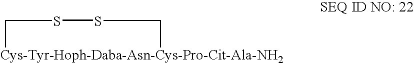

X₁ is Cys, X₂ is Tyr, X₃ is Hoph, X₄ is Daba, X₅ is Pro, X₆ is Cit, X₇ is Ala, X₈ is nothing, and X₉ is S in Claim 2 and 6

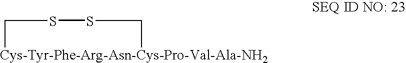

X₁ is Cys, X₂ is Tyr, X₃ is Phe, X₄ is Arg, X₅ is Pro, X₆ is Val, X₇ is Ala, X₈ is nothing, and X₉ is S in Claim 2 and 6

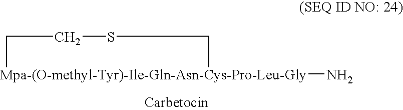

X₁ is Mpa, X₂ is (O-methyl-Tyr), X₃ is Ile, X₄ is Gln, X₅ is Pro, X₆ is Leu, X₇ is Gly, X₈ is nothing, and X₉ is CH₂ in Claim 2 and 6,

wherein Mpa stands for β-mercaptopropionic acid; wherein the CH₂-S-group thereof is bonded to the cystein portion via a thioether bond i position 6 giving the structure for SEQ ID NO: 24 as follows:

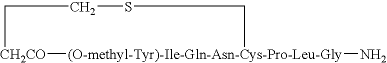

wherein (O-methyl-Tyr) stands for O-methyltyrosin of the chemical formula:

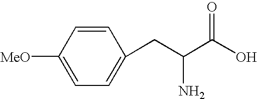

wherein Cha stands for cyclohexylalanine,

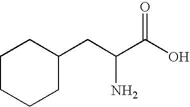

Hoph stands for homophenylalanine,

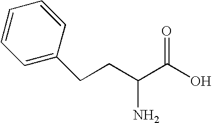

Cit stands for citruline,

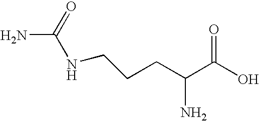

Daba stands for diaminobutyric acid, and

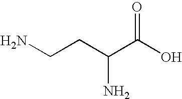

Hos stands for homoserine.

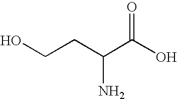

Annetocin has been isolated from the earthworm, as described in Oumi T, Ukena K, Matsushima O, Ikeda T, Fujita T, Minakata H, Nomoto K, Annetocin: an oxytocin related peptide isolated from the earthworm, Eisenia Foetida, Biochem Biophys Res Commun 1994 Jan. 14; 198(1): 393-399. The uterotonic activity and myometrial receptor affinity of carbetocin is described in Atke A and Vilhardt H, Acta Endocrinologica (Copenh) 1987, 115: 155-160.

Other substances with oxytocin activity could also be used, such as naturally occurring or artificially modified variants, analogues, and derivatives of oxytocin, mesotocin, isotocin, and annetocin. Such substances could be obtained by addition, insertion, elimination, or substitution of at least one amino acid in these hormones. By a substance with an oxytocin like activity is also understood precursors, metabolites such as metabolic derivatives e.g. metabolic degradation products, agonists, or analogues of the substances mentioned herein displaying the same properties. When one or more amino acids are added to a substance with oxytocin activity, it is preferred to add 1-3 amino acids to the carboxyl terminal. Metabolic derivatives or metabolic degradation products may be oxytocin like peptides e.g. with nine amino acids such as oxytocin, mesotocin, isotocin, and annetocin from which one or more amino acids has been deleted from either the carboxyl terminal end or the amino terminal end or both the carboxyl terminal and the amino terminal end, preferably 1-3 amino acids from each terminal. It could be ascertained that these variants are analogues of oxytocin, mesotocin, isotocin or annetocin by immunological methods, e.g. RIA (radioimmunoassay), IRMA (radiometric methods), RIST (radioimmunosorbent test), and RAST (radioallergosorbent test). The invention also includes substances having at least 50, 60, 70, 80 and most preferably 90% homology to oxytocin, and showing oxytocin activity.

As mentioned above, there are indications that addition of one or more amino acids to the oxytocin molecule may give a molecule that stimulates plant growth. One example of such a molecule is SEQ ID NO: 8.

As mentioned above, there are indications that subfragments of the oxytocin molecule may stimulate plant growth. Examples of subfragments of the oxytocin molecule are the following compounds: SEQ ID NO: 9, SEQ ID NO: 10, SEQ ID NO: 11, SEQ ID NO: 12, SEQ ID NO: 13, SEQ ID NO: 14, and SEQ ID NO: 15.

There is also a possibility to create new compounds with oxytocin activity by means of computer simulation. Methods for computer simulation are known by a person skilled in the art, e.g. as described in EP 0660 210 A2. Eight new compounds have been created by means of computer simulation, namely the following peptides: SEQ ID NO: 16, SEQ ID NO: 17, SEQ ID NO: 18, SEQ ID NO: 19, SEQ ID NO: 20, SEQ ID NO: 21, SEQ ID NO: 22, and SEQ ID NO: 23.

The invention also relates to the peptides mentioned above in both D- and L-form, and racemates thereof. Especially the invention relates to the L-form. By inversion of the peptide sequence thereof, the D-form could be converted to the L-form. The effect of the D- and L-forms are the same. These and the peptides above can be produced by methods known to a person skilled in the art, e.g. according to Merrifield, P. B., “Solid Phase Synthesis”, Angew. Chemie, 1985, No. 97, p. 801.

Another object of the invention is a composition comprising at least one substance with oxytocin activity in order to stimulate plant growth, in mixture or otherwise together with at least one suitable adjuvant. It is preferred that the substance is selected from the group consisting of compounds with the formula SEQ ID NO: 2. It is even more preferred that the substance is selected from the group consisting of the following compounds: SEQ ID NO: 1, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ. ID NO: 13, SEQ ID NO: 14, SEQ ID NO: 15, SEQ ID NO: 16, SEQ ID NO: 17, SEQ ID NO: 18, SEQ ID NO. 19, SEQ ID NO: 20, SEQ ID NO: 21, SEQ ID NO: 22, SEQ ID NO: 23, and SEQ ID NO: 24.

General principals in administration of growth stimulating agents are to have the substances mentioned above in mixture or otherwise together with adjuvants such as water or organic solvents such as alcohol or coating agents such as gels, which may delay the delivery of a substance with oxytocin activity. Drying such agents will delay the delivery of oxytocin until water is absorbed by the coating agents. All these agents can be used as a solvent for the substance or substances with oxytocin activity. The substance is taken up by the plant via the root or the leaf and may be formulated in order to make it more or less water-soluble. The water solubility may be regulated by binding the substance to a carrier. A carrier is an organic group making the substance more or less hydrophilic. An example of a carrier making the substance more hydrophilic is an amide group. An example of a carrier making the substance less hydrophilic is a methyl group. When the substance bound to a carrier has been assimulated to the plant, the carrier will be removed enzymatically by using a naturally occurring enzyme of the plant substances with oxytocin activity can be used in many ways as a stimulator of dormancy breaking, germination and growth. One example would be to speed up germination and early growth of wheat by application of a substance with oxytocin activity to wheat seeds before sowing. In this way, wheat would overcome competition by weeds. A substance with oxytocin activity can be applied to plants at one developing stage or several different stages depending on which effect of a substance with oxytocin activity that is desired.

As used in the present application:

the term “fresh weight” (abbreviated fw) means the weight of the plant before drying;

the term “dry weight” (abbreviated dw) means the weight of the plant after drying;

the term “dry matter” (abbreviated dm) means the plant materia obtained after drying. When the dry matter is expressed in %, this means the ratio between the dry weight and the fresh weight for a specific part of the plant.

All publications mentioned herein are hereby incorporated by reference. By the expression “comprising” we understand including but not limited to. Thus, other non-mentioned substances or additives may be present.

The invention will be illuminated by the following Examples, which are only intended to illuminate and not restrict the invention in any way.

### EXAMPLES

Statistical analysis was performed by means of 2-way ANOVA followed by Bonferoni's test for post hoc comparison. Results are given as mean values. Differences in the number of germinated seeds, coleoptile length, root length (Example 1) and growth of lettuce (Example 2) were assessed by Student's t-test for independent means. Results were considered significant when p<0.05.

### Example 1

### Germination Test

### Materials and Methods

In each of 10 Petri dishes with a diameter of 10 cm, 100 seeds of bent (Agrostis tenuis) are placed together with two filter papers. To five of the Petri dishes is added 4.5 ml of a 1 μg/ml aqueous solution of oxytocin. To the other five Petri dishes is added the same amount of tap water. All ten Petri dishes are then placed in darkness for germination during fourteen days at a temperature of 18° C.

In each of 10 Petri dishes with a diameter of 10 cm, 100 seeds of winter wheat (Triticum sativum) are placed together with two filter papers. To five of the Petri dishes is added 4.5 ml of a 1 μg/ml aqueous solution of oxytocin. To the other five Petri dishes is added the same amount of tap water. All ten Petri dishes are placed in darkness for germination during fourteen days at a temperature of 18° C.

### Results

Germination of seeds of winter wheat (Triticum sativum) and bent (Agrostis tenuis) was affected by oxytocin (Table 1). The treatment denoted “Untreated” refers to treatment with tap water only. As is seen from the Table, oxytocin increased the number of germinated seeds and stimulated the growth of seeds of winter wheat. The results were similar for seeds of Agrostis tenuis. However, only the increase in root length was significant in the latter species.

TABLE 1
Mean number of germinated seeds, coleoptile length and
root length of Triticitm sativum and Agrostis tenuis after
treatment of the seeds with or without oxytocin.

| | | Germinated | Coleoptile | Root length |
|---|---|---|---|---|
| Species | Treatment | seeds | length [mm] | [mm] |
| Triticum | | | | |
| sativum | | | | |
| | Untreated | 89.3 | 0.0 | 2.2 |
| | Oxytocin | 97.0 | 27.4 | 36.0 |
| | P-value | 0.005 | <0.001 | <0.001 |
| Agrostis | | | | |
| tenuis | | | | |
| | Untreated | 5.4 | 37.2 | 12.0 |
| | Oxytocin | 9.8 | 39.1 | 15.7 |
| | P-value | 0.156 | 0.524 | 0.025 |

### Example 2

### Growth Test

### Materials and Methods

Germination

The plant used was lettuce (Lactuca sativa), sort “Calgary” and non-disinfected ecological seeds were used. In the same manner as in Example 1, 150 seeds are germinated in oxytocin solution and 150 seeds are germinated in tap water, in both cases in darkness.

Growth Phase

After germination for six days, the germs are put into 1 litre test vessels with four germs per vessel. To ten vessels are added oxytocin treated germs and to ten other vessels are added germs treated with tap water, giving totally eighty plants. Each vessel contains 1 litre 300 μM calcium sulphate solution. Other nutrients were added on the first and third day and from day five until harvest, 21 days after transferring germs to vessels. Increasing volumes from a stock nutrient solution (24 mM potassium, 2.5 mM magnesium, 22.3 mM ammonium, 4 mM phosphorus, 46.9 mM nitrate, 1 mM chlorine and trace elements) were supplied to meet the immediate nutrient demand of plants with a relative growth rate of 20% day⁻¹. Three days after the transport of the germs to the vessels, 1 mg of oxytocin was added to half of the oxytocin treated germs and to half of the germs treated with tap water giving a oxytocin concentration of 1 μg/ml. The growth phase experiment was performed in a climate chamber with 14 hours illumination per day at a temperature of 18° C. at light and at a temperature of 14° C. in darkness.

Accordingly, the eighty plants have been treated as follows:

20 plants (5 vessels each having 4 plants)—treated with tap water during germination and growth (denoted −ox/−ox);

20 plants (5 vessels each having 4 plants)—treated with oxytocin solution during germination and with tap water during growth (denoted +ox/−ox);

20 plants (5 vessels each having 4 plants)—treated with tap water during germination and with oxytocin solution during growth (denoted −ox/+ox);

20 plants (5 vessels each having 4 plants)—treated with oxytocin solution during germination and growth (denoted +ox/+ox).

### Results After the Growth Phase

Lettuce treated with oxytocin at germination (+ox/−ox) or during the growth in nutrient solution (−ox/+ox) showed a significant increase in growth compared with control (−ox/−ox) (Table 2). In particular, the root growth is stimulated by oxytocin. The content of dry matter was also increased by these treatments. Treatment of lettuce during both germination and growth in nutrient solution (+ox/+ox) gave no effects compared with control. The root length was even inhibited when oxytocin was available during the whole experiment period. The same was found for the content of dry matter. The results show that oxytocin stimulates growth rate, especially the root growth, and increases the accumulation of organic matter in plant tissues, whereas the water content decreases. The results show that different effects may be induced depending on when and how many times oxytocin is applied.

TABLE 2
Growth of lettuce, Lactuca sativa, treated with or
without oxytocin. Treatment during germination/treatment during
growth, −ox = without oxytocin, +ox = with oxytocin.
Numbers following of the same letter are not significant at
the 5% level. This means that “a” and “b” for two values
differ significantly from each other at the 5% level but not with
“a” and “a” or V and “ab”. The P-value refers to
the ANOVA value for the model.

| | −ox/−ox | +ox/−ox | −ox/+ox | +ox/+ox | P-value |
|---|---|---|---|---|---|
| Whole plant, | 6.33b | 6.59a | 6.51ab | 6.41ab | 0.0530 |
| fw, g | | | | | |
| Whole plant, | 0.730b | 0.782a | 0.797a | 0.721b | 0.0153 |
| dw, g | | | | | |
| Shoot, fw, g | 4.436a | 4.559a | 4.508a | 4.466a | 0.3204 |
| Shoot, dw, g | 0.603b | 0.641ab | 0.656a | 0.596b | 0.0427 |
| Shoot, dm, % | 13.60b | 14.06ab | 14.55a | 13.34b | 0.0448 |
| Root, fw, g | 1.89b | 2.03a | 2.00a | 1.94ab | 0.0279 |
| Root, dw, g | 0.126b | 0.141a | 0.141a | 0.126b | 0.0039 |
| Root, dm, % | 6.70ab | 7.03a | 6.92ab | 6.44b | 0.1329 |
| Root length, cm | 23.4a | 24.4a | 23.6a | 21.00b | 0.0053 |
| Shoot/root, fw | 2.35a | 2.24a | 2.25a | 2.30a | 0.1998 |
| Shoot/root, dw | 4.80a | 4.59a | 4.67a | 4.76a | 0.6165 |

1.-8. (canceled)

9. A method of stimulating plant growth, comprising administering at least one substance with oxytocin activity to a seed or a plant.

10. A method according to claim 9, wherein said at least one substance is:
(SEQ ID NO:2)
X₉-S
X₁-X₂-X₃-X₄-Asn-Cys-X₅-X₆-X₇-X₈-NH₂
wherein X₁ is selected from the group consisting of Cys, Mpa and nothing,
X₂ is selected from the group consisting of Tyr, (O-methyl-Tyr), Phe, and nothing,
X₃ is selected from the group consisting of Ile, Val, Hoph, Phe, Cha, and nothing,
X₄ is selected from the group consisting of Gln, Ser, Thr, Cit, Arg, and Daba,
X₅ is selected from the group consisting of Pro, and nothing,
X₆ is selected from the group consisting of Ile, Leu, nothing, Val, Hos, Daba, Thr, Arg, and Cit,
X₇ is selected from the group consisting of Gly, nothing, and Ala,
X₈ is selected from the group consisting of Gly and nothing, and
X₉ is selected from the group consisting of CH₂ and S;
and salts thereof.

11. A method according to claim 9, wherein said at least one substance is selected from the group consisting of: SEQ ID NO: 1, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 14, SEQ ID NO: 15, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, and SEQ ID NO: 24.

12. A method according to claim 10, wherein said at least one substance is selected from the group consisting of: SEQ ID NO: 1, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 14, SEQ ID NO: 15, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, and SEQ ID NO: 24.

13. A method according to claim 9, wherein said substance is in a mixture.

14. A method according to claim 13, wherein said mixture further comprises at least one suitable adjuvant.

15. A method according to claim 10, wherein said substance is in a mixture.

16. A method according to claim 15, wherein said mixture further comprises at least one suitable adjuvant.

17. A method according to claim 11, wherein said substance is in a mixture.

18. A method according to claim 17, wherein said mixture further comprises at least one suitable adjuvant.

19. A method according to claim 12, wherein said substance is in a mixture.

20. A method according to claim 19, wherein said mixture further comprises at least one suitable adjuvant.

21. A method according to claim 13, wherein said substance is bound to a carrier.

22. A method according to claim 14, wherein said substance is bound to a carrier.

23. A plant growth stimulation mixture, comprising an effective plant stimulating concentration of at least one substance with oxytocin activity, wherein said at least one substance is:
(SEQ ID NO:2)
X₉-S
X₁-X₂-X₃-X₄-Asn-Cys-X₅-X₆-X₇-X₈-NH₂
wherein X₁ is selected from the group consisting of Cys, Mpa and nothing,
X₂ is selected from the group consisting of Tyr, (O-methyl-Tyr), Phe, and nothing,
X₃ is selected from the group consisting of Ile, Val, Hoph, Phe, Cha, and nothing,
X₄ is selected from the group consisting of Gln, Ser, Thr, Cit, Arg, and Daba,
X₅ is selected from the group consisting of Pro, and nothing,
X₆ is selected from the group consisting of Ile, Leu, nothing, Val, Hos, Daba, Thr, Arg, and Cit,
X₇ is selected from the group consisting of Gly, nothing, and Ala,
X₈ is selected from the group consisting of Gly and nothing, and
X₉ is selected from the group consisting of CH₂ and S;
and salts thereof.

24. A mixture according to claim 23, wherein the mixture further comprises at least one suitable adjubvant.

25. A mixture according to claim 23, wherein said at least one substance is selected from the group consisting of: SEQ ID NO: 1, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 14, SEQ ID NO: 15, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, and SEQ ID NO: 24.

26. A mixture according to claim 23, wherein said at least one substance is bound to a carrier.

27. A mixture according to claim 24, wherein said at least one substance is bound to a carrier.

28. A mixture according to claim 25, wherein said at least one substance is bound to a carrier.
